(19) United States
(12) Patent Application Publication
(10) Pub. No.: US 2003/0046242 A1
(43) Pub. Date: Mar. 6, 2003

(54) Third party billing intervention for mobile internet access

(75) Inventors: Maria Azua Himmel, Yorktown Heights, NY (US); Herman Rodriguez, Austin, TX (US); Newton James Smith JR., Austin, TX (US); Clifford Jay Spinac, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/942,149

(22) Filed: Aug. 30, 2001

(51) Int. Cl. G06F 17/60

(52) U.S. Cl. 705/52

(57) ABSTRACT

A method, computer program, and data processing system for accepting Internet access charges for a user examining a particular website is disclosed. The present invention enables businesses, organizations, and individuals to entice users that must pay for Internet access time to browse their websites freely without concern for cost.

### BACKGROUND OF THE INVENTION

1. Technical Field:

The present invention relates generally to the automated billing of Internet access. More specifically, the present invention provides a method, computer program, and data processing system for billing third-parties for users' Internet access, when certain pages are accessed by those users.

2. Description of Related Art:

Since the introduction of the World Wide Web and the subsequent commercialization of the Internet, the world has become a considerably more connected place. No longer bound to the primitive communications interfaces of the past, the Internet is now host to a variety of powerful communications media, including interactive hypertext browsing (the World Wide Web), instant messaging, streaming video and audio, and multimedia electronic mail.

Hypertext is a method of organizing textual and graphical information on a computer screen. Information is organized into “pages,” which resemble printed pages in a book or (perhaps more accurately) printed scrolls (since a hypertext page can be of any length). The primary difference between hypertext and the printed word, however, lies in the fact that hypertext pages can contain links. That is, a portion of a hypertext document, such as a phrase or a graphic, may be made sensitive to clicking by the mouse such that when the user clicks on that portion, the user is directed to a new page or a different section of the current page. For instance, it is a common practice to make bibliographic citations into links. When a user clicks on one of these citations, the cited text appears on the screen. Hypertext documents are displayed using a program called a “browser.”

The largest and best-known repository of hypertext documents is the World Wide Web, a loosely bound collection of publicly accessible hypertext documents stored on computers the world over. The World Wide Web has become the preferred Internet medium for publishable information as well as for providing such interactive features as online shopping-to the extent that the terms Internet and World Wide Web are virtually synonymous to some.

Browsers can download hypertext documents from a server with the HyperText Transfer Protocol (HTTP). HTTP allows a browser to request documents or files from a server and receive a response. In addition, when browser users enter information into a form embedded into a hypertext page, the browser transmits the information to a server using HTTP. Form information can then be passed along to applications residing on the server by way of the Common Gateway Interface (CGI). Those applications can then return a result, which may be written in HTML.

Likewise, the mobile telephone has ushered in a new era in interpersonal communications. While the late 1990s' widespread consumer interest in the Internet made ours a wired world, technical advances and increased consumer appeal are ushering in a new “wireless world.”

A number of mobile telephone manufacturers and service providers cater to a growing base of mobile telephone subscribers.

The logical extension of these two technological revolutions is mobile (or wireless) Internet access. A number of devices and services today allow users to access the Internet from virtually anywhere. Portable devices that may be used to access the Internet include personal digital assistants and mobile telephones.

Wireless services, such as mobile telephone usage, are generally billed based on the amount of time spent “on the air” or “airtime.” Mobile Internet users, therefore, have a disincentive to spend time simply browsing through websites. Businesses that rely on a web presence for marketing purposes are somewhat disadvantaged by mobile Internet service, in that mobile Internet users are less likely to “window shop” online, as they must pay for the time.

Therefore, it would be desirable for businesses to have a way of enticing mobile Internet customers that must pay for airtime to browse their websites freely.

### SUMMARY OF THE INVENTION

Accordingly, the present invention provides a method, computer program, and data processing system for accepting Internet access charges for a user examining a particular website. The present invention enables businesses, organizations, and individuals to entice users that must pay for Internet access time to browse their websites freely without concern for cost.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a mobile Internet billing intervention system in accordance with a preferred embodiment of the present invention;

FIG. 2 is an external view of a personal digital assistant (PDA) that may be used in a preferred embodiment of the present invention;

FIG. 3 is a block diagram of a personal digital assistant (PDA) that may be used in a preferred embodiment of the present invention;

FIG. 4 is a block diagram of a server that may be used in a preferred embodiment of the present invention;

FIG. 5 is a diagram of the headers in an Internet Protocol (IP) data packet, which may be used to identify source and destination addresses in a preferred embodiment of the present invention'

FIG. 6 is a diagram depicting an operation of intervening in mobile Internet billing in accordance with a preferred embodiment of the present invention;

FIG. 7 is a diagram depicting the continuation of the process depicted in FIG. 6;

FIG. 8 is a diagram depicting an operation of restoring default billing in accordance with a preferred embodiment of the present invention;

FIG. 9 is a diagram of a billing database in accordance with a preferred embodiment of the present invention; and

FIG. 10 is a flowchart representation of a process of mobile Internet billing intervention in accordance with a preferred embodiment of the present invention.

### DETAILED DESCRIPTION OF THE PREFERRED EMBODIMENT

FIG. 1 is a diagram depicting an overall view of a mobile Internet billing intervention system in accordance with a preferred embodiment of the present invention. A mobile Internet user accesses the Internet through a wireless link between personal digital assistant (PDA) 100 and antenna station 102, operated by a mobile Internet service provider (mobile ISP). PDA 100 could be, for instance, a Palm VII organizer, manufactured by Palm, Inc. One of ordinary skill in the art will recognize that PDA 100 is a mere representative of a number of wireless devices that may be used to provide Internet access, including certain cellular telephones, laptop computers, and the like. Supervisory server 104 is associated with antenna station 102 and monitors network traffic passing through antenna station 102. Supervisory server 104 also controls billing database 106, which stores information regarding the billing of mobile ISP customers for mobile Internet access.

Antenna station 102 is connected to the broader Internet 108, which is connected to, among other things, a number of web servers such as web server 110, which provides World Wide Web media content to web clients, such as PDA 100.

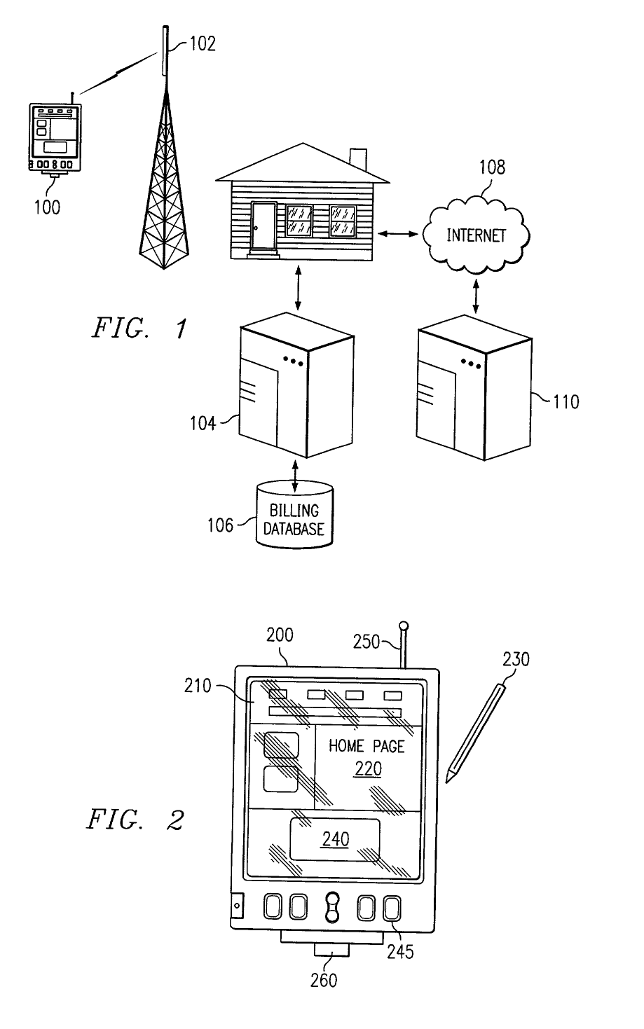

FIG. 2 is an external view of a PDA 200 that may be used in a preferred embodiment of the present invention. PDA 200 includes a touch-sensitive screen 210, which in FIG. 2 is depicted as displaying a web browser 220. PDA 200, being a type of general-purpose computer, is capable of operating a number of different software packages. Web browser 220 may execute on top of an operating system, such as the PalmOS operating system, developed by Palm, Inc.

Stylus 230 may be used to apply pressure to touch-sensitive screen 210. Thus, stylus 230 may be used as a pointing device, like a mouse or trackball. Stylus 230 may also be used like a pen in conjunction with writing surface 240, which is also touch-sensitive, to write alphanumeric and other character-based data. Keys, such as key 245 provide an additional input mechanism.

Antenna 250 provides a wireless communication link to other devices. Antenna 250 allows PDA 200 to communicate with an antenna station, such as antenna station 102 in FIG. 1, so as to gain access to the Internet or other network. Cradle connector 260 allows PDA 200 to be connected through a PDA cradle interface to a desktop or laptop computer for exchange of information.

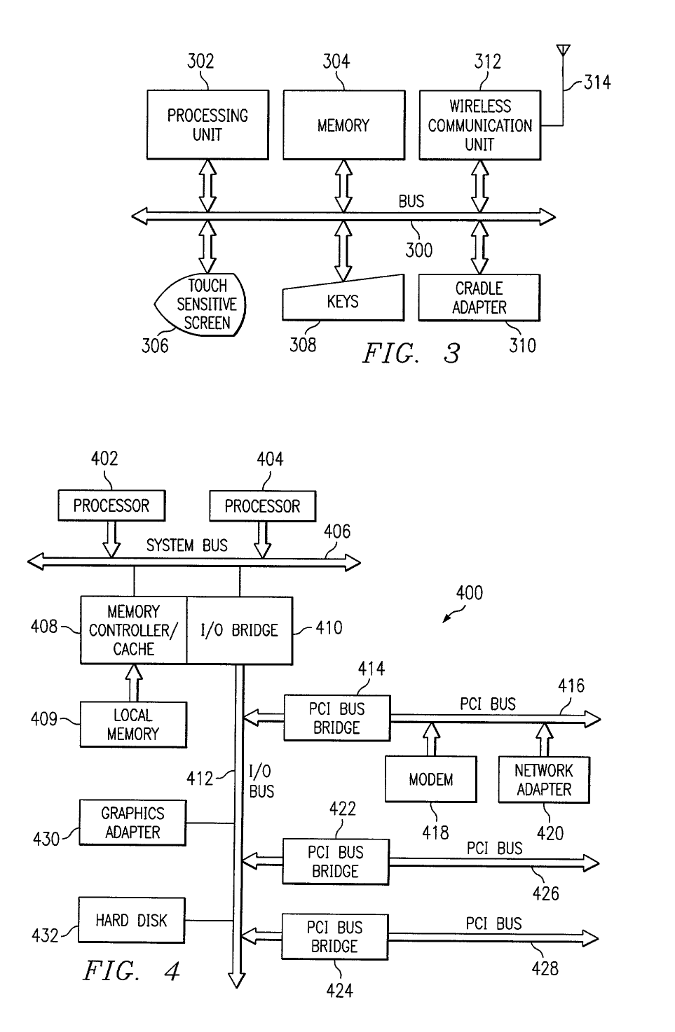

FIG. 3 is a block diagram of a PDA that may be used in a preferred embodiment of the present invention. Local bus 300 connects the various components of the PDA. Processing unit 302, connected to bus 300, executes instructions stored in memory 304, which is also connected to local bus 300. Processing unit 302 may comprise a single processor, such a microprocessor, or it may comprise multiple processors so as to allow the execution of multiple instructions simultaneously. Any number of processors could be used in processing unit 302. An example of a suitable processor is the Dragonball EZ processor, manufactured by Motorola, Inc. Many different types of memory are available and suitable for use within the PDA depicted in FIG. 3. Memory is generally classified as volatile and non-volatile memory. Volatile memory types store data temporarily while the data processing system is operating, but lose their data once the data processing system's power is turned off. Most volatile memory in use today is “random access memory,” (RAM) meaning that data and instructions may be read from or written to any portion of the memory at any time. Common random access memory types well-known to those skilled in the art include static random access memory (SRAM) and dynamic random access memory (DRAM).

Non-volatile memory types retain their information, even when the data processing system is turned off. Non-volatile memory types are generally referred to as “read-only memory” (ROM). Many types of non-volatile memory exist. Programmable read-only memory (PROM) may be programmed with permanent data using a PROM programming device. Erasable programmable read-only memory (EPROM) can be erased of its data contents, through such means as ultraviolet radiation or through electric current (as with an electrically-erasable PROM or EEPROM). Flash memory and non-volatile random-access memory (NVRAM) are two memory media that may be written to and erased within working circuits without the use of a memory programming device.

Memory 304 may store data to be operated upon by processing unit 302, it may store instructions to be executed by processing unit 302, or it may store both. In FIG. 3, a single memory module is depicted, although many memory arrangements are possible. Cache memory, which is a high speed memory used for temporary storage of data and instructions to be stored to read from a primary bank of memory may be used. Also, certain systems designed with what is known as a “Harvard architecture” use separate memory and buses for data and instructions.

Alternatively, a microcontroller, such as an 8051 microcontroller, manufactured by Intel Corporation, could be used in place of processing unit 302 and memory 304. A microcontroller is a monolithic integrated circuit containing both a processor unit and memory.

Touch-sensitive screen 306 provides both input and output for the PDA. Touch-sensitive screen 306 preferably comprises some kind of liquid crystal display (LCD) covered by a transparent digitizer pad. The digitizer is sensitive to touch and can detect the X and Y coordinates of a point of contact with the pad. Keys 308 provide additional input means for the PDA.

Cradle adapter 310 allows PDA to be connected to a desktop or laptop computer for data exchange. Wireless communications unit 312 provides circuitry for wireless data interchange through antenna 314. Wireless communications unit 312 and antenna 314 may be used for providing mobile Internet access.

Those of ordinary skill in the art will appreciate that the hardware depicted in FIG. 3 may vary. For example, other peripheral devices may be used in addition to or in place of the hardware depicted. The depicted example is not meant to imply architectural limitations with respect to the present invention.

Referring to FIG. 4, a block diagram of a data processing system that may be implemented as a server, such as server 104 or server 110 in FIG. 1, is depicted in accordance with a preferred embodiment of the present invention. Data processing system 400 may be a symmetric multiprocessor (SMP) system including a plurality of processors 402 and 404 connected to system bus 406. Alternatively, a single processor system may be employed. Also connected to system bus 406 is memory controller/cache 408, which provides an interface to local memory 409. I/O bus bridge 410 is connected to system bus 406 and provides an interface to I/O bus 412. Memory controller/cache 408 and I/O bus bridge 410 may be integrated as depicted.

Peripheral component interconnect (PCI) bus bridge 414 connected to I/O bus 412 provides an interface to PCI local bus 416. A number of modems may be connected to PCI bus 416. Typical PCI bus implementations will support four PCI expansion slots or add-in connectors. Communications links to other data processing systems may be provided through modem 418 and network adapter 420 connected to PCI local bus 416 through add-in boards.

Additional PCI bus bridges 422 and 424 provide interfaces for additional PCI buses 426 and 428, from which additional modems or network adapters may be supported. In this manner, data processing system 400 allows connections to multiple network computers. A memory-mapped graphics adapter 430 and hard disk 432 may also be connected to I/O bus 412 as depicted, either directly or indirectly.

Those of ordinary skill in the art will appreciate that the hardware depicted in FIG. 4 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 4 may be, for example, an IBM eServer pSeries, a product of International Business Machines Corporation in Armonk, New York, running the Advanced Interactive Executive (AIX) operating system.

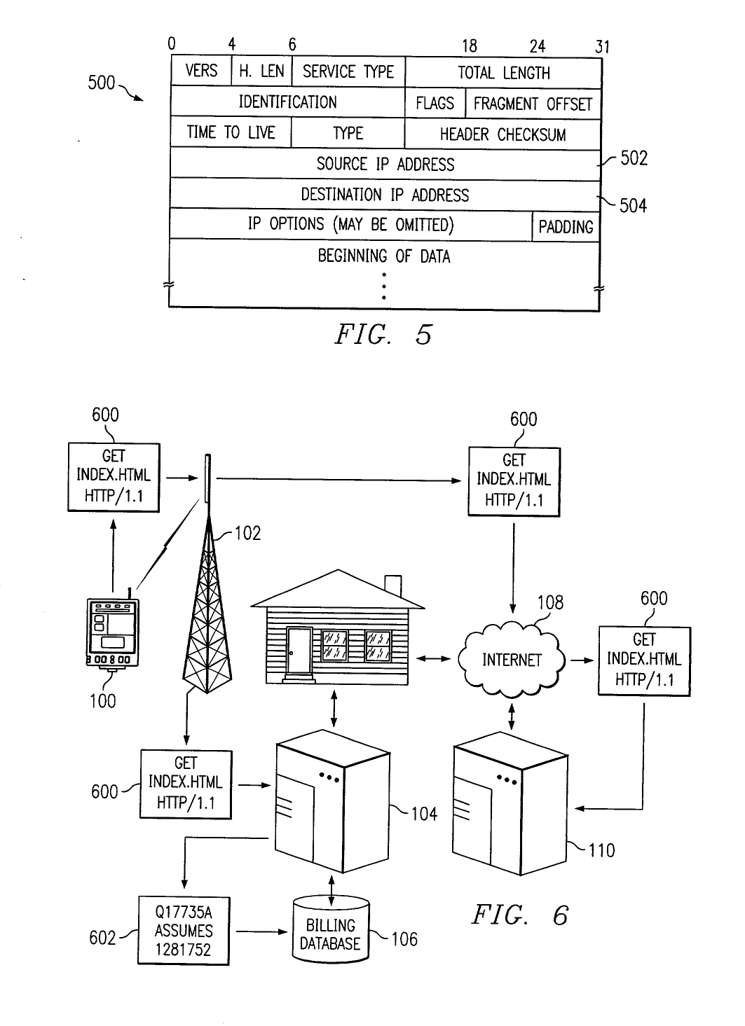

Network communications in the system depicted in FIG. 1 will preferably be conducted using the TCP/IP suite of network protocols. Data transmitted using TCP/IP is sent in the form of packets. These packets contain various headers that include useful information regarding the source, destination, and characteristics of the information being transmitted. FIG. 5 depicts headers 500 used in IP (Internet Protocol) packets. Source IP address 502 tells where a packet originates from. Destination IP address 504 tells where a packet is being transmitted to. Thus, a server such as supervisory server 104 in FIG. 1, that monitors packets, can identify when a packet is being sent from one machine in a network to another. Thus in FIG. 1, supervisory server 104 can monitor the headers of IP packets passing through antenna station 102 to note when PDA 100 is communicating with 110.

FIG. 6 is a diagram depicting a process of billing intervention in accordance with a preferred embodiment of the present invention. PDA 100 issues an HTTP request 600 for a web page located on web server 110. The information providers providing the content on web server 110 have agreed to pay for mobile Internet charges for mobile Internet users that visit the web site(s) on web server 110. HTTP request 600 is sent via wireless link to antenna station 102.

Supervisory server 104 monitors the packets passing through antenna station 102 and notices that an HTTP request is being transmitted from PDA 100 to server 110. Supervisory server 104 is programmed to recognize requests sent to server 110. Supervisory server 104 submits an update 602 to billing database 106 to indicate that the information providers associated with server 110 will be paying for the mobile Internet access of PDA 100.

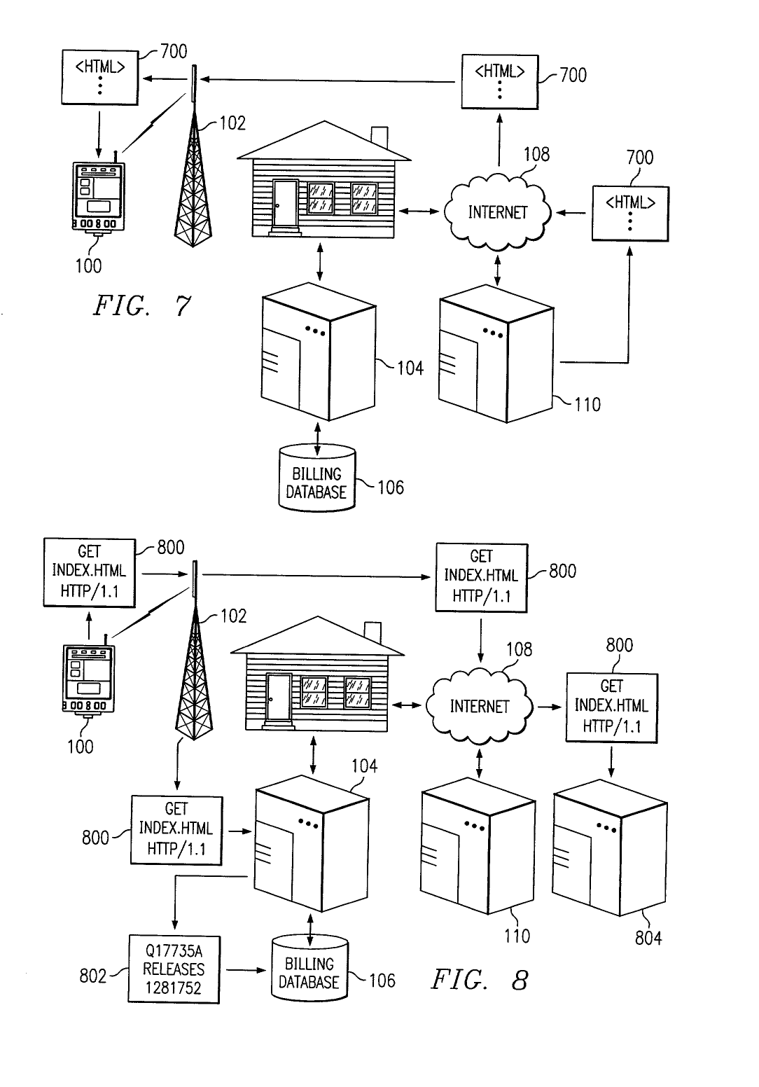

Meanwhile, HTTP request 600 is transmitted from antenna station 102, over Internet 108, to server 110. As shown in FIG. 7, server 110 replies by transmitting the requested document 700 through Internet 108 and antenna station 102 to PDA 100.

FIG. 8 depicts what happens when the user of PDA 100 next requests a web page associated with a different web server 804 and different information provider. An HTTP request 800 is sent from PDA 100 through antenna station 102. This time supervisory server 104 detects that HTTP request 800 is directed toward server 804, rather than server 110. In response, supervisory server 104 submits an update 802 to billing database 106 to indicate that the information providers associated with server 110 are no longer assuming the charges for the mobile Internet access of PDA 100. Meanwhile, the web request is forwarded through Internet 108 to server 804 for processing.

In a preferred embodiment, the operation depicted in FIG. 8 for ending billing intervention will be supplemented with a timer system so that the billing intervention ends a certain number of minutes after the last communication between PDA 100 and server 110, so that the information providers associated with server 110 will not be continuously charged if PDA 100 is left operating with web server 110's website displayed.

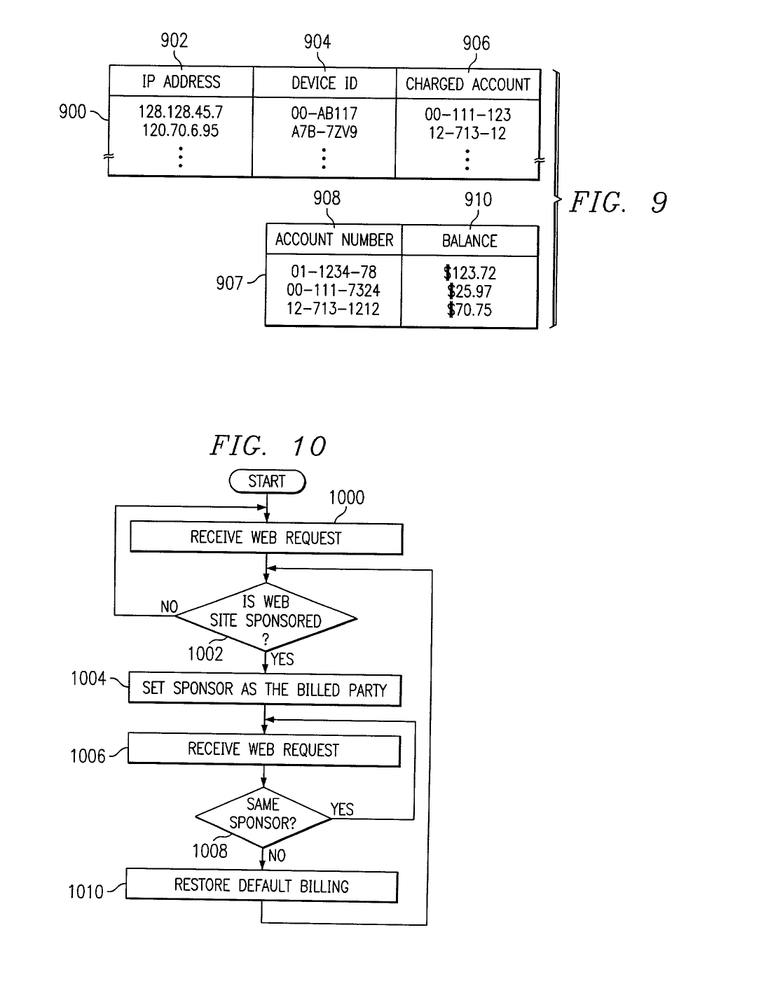

FIG. 9 is a diagram depicting a billing database in accordance with a preferred embodiment of the present invention. Table 900 maps an IP (network) address 902 of a mobile Internet device with a unique device ID 904 and an account number 906 to be charged for Internet access of the device. A mapping between IP address 902 and device ID 904 is helpful, since a device may be dynamically allocated an IP address each time an Internet connection is established. Thus, a given device only has one device ID, but may assume a different IP address each time it initiates a wireless Internet connection. Table 907 maps an account number 908 with a balance of charges 910.

To change the party billed, as depicted in FIG. 6, charged account field 906 is changed for the particular mobile Internet device in question. Balance field 910 for the intervening party is then charged, rather than the user of the device. Charged account field 906 can be simply changed back to the device user's account number when the default billing arrangement is to be restored.

FIG. 10 is a flowchart representation of a process of billing intervention in accordance with a preferred embodiment of the present invention. A request for a web document is received (step 1000). If the request is for a website sponsored by an information provider which is (step 1002), the information provider sponsoring the site is established as the billed party (step 1004). If not, the process cycles to step 1000.

Another web request is received (step 1006). If this request is for a website sponsored by the same information provider and under the same terms (step 1008), the process cycles back to step 1006. Otherwise, the default billing arrangement, where the mobile Internet device user is charged, is restored (step 1010), and the process cycles to step 1000.

One of ordinary skill in the art will recognize that a number of variations may be made to the basic embodiment herein described, without departing from the scope of the claimed invention. For example, certain non-wireless Internet provider charge users for the amount of time spent online. The same billing intervention scheme could be used with non-wireless Internet customers, therefore, as all that is required to provide the same scheme is the ability to monitor network activity, which can be done with both wired and wireless network links.

Another contemplated variation on the basic embodiment herein described would be to have the web server being communicated with submit the IP address of the web client device (e.g., PDA 100 in FIG. 1) to the web client's Internet service provider, rather than having the Internet service provider monitor the network activity between the client and server. The method by which the Internet service provider discovers that a communication between the client and web server is taking place is unimportant, and any number of techniques may be used to perform this step.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method comprising:
receiving from a client a request for a web document;
in response to receiving the request, charging a party associated with the web document for subsequent network activity of the client.

2. The method of claim 1, comprising:
in response to receiving a second request for a second web document that is not associated with the party, discontinuing charging the party for the network activity of the client.

3. The method of claim 1, wherein the client is a mobile computer.

4. The method of claim 3, wherein the mobile computer is a portable digital assistant.

5. The method of claim 3, wherein the mobile computer is within a mobile telephone.

6. The method of claim 1, comprising:
after a pre-determined time interval has elapsed, discontinuing charging the party for the network activity of the client.

7. A computer program in a computer-readable medium, comprising:
receiving from a client a request for a web document;
in response to receiving the request, charging a party associated with the web document for subsequent network activity of the client.

8. The computer program of claim 7, comprising:
in response to receiving a second request for a second web document that is not associated with the party, discontinuing charging the party for the network activity of the client.

9. The computer program of claim 7, wherein the client is a mobile computer.

10. The computer program of claim 9, wherein the mobile computer is a portable digital assistant.

11. The computer program of claim 9, wherein the mobile computer is within a mobile telephone.

12. The computer program of claim 7, comprising:
after a pre-determined time interval has elapsed, discontinuing charging the party for the network activity of the client.

13. A data processing system comprising:
a bus system;
a processing unit connected to the bus system and including at least one processor;
memory connected to the bus system; and
a set of instructions in the memory, wherein the processing unit executes the set of instructions to perform:
receiving from a client a request for a web document; and
in response to receiving the request, charging a party associated with the web document for subsequent network activity of the client.

14. The data processing system of claim 13, wherein the processing unit executes the set of instructions to perform:
in response to receiving a second request for a second web document that is not associated with the party, discontinuing charging the party for the network activity of the client.

15. The data processing system of claim 13, wherein the client is a mobile computer.

16. The data processing system of claim 15, wherein the mobile computer is a portable digital assistant.

17. The data processing system of claim 15, wherein the mobile computer is within a mobile telephone.

18. The data processing system of claim 13, wherein the processing unit executes the set of instructions to perform:
after a pre-determined time interval has elapsed, discontinuing charging the party for the network activity of the client.
